(19) United States
(12) Patent Application Publication
(10) Pub. No.: US 2005/0122508 A1
(43) Pub. Date: Jun. 9, 2005

(54) Method and apparatus for reviewing defects

(76) Inventors: Sachio Uto, Yokohama (JP); Yoshimasa Ohshima, Yokohama (JP); Minori Noguchi, Mitsukaido (JP); Toshiei Kurosaki, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/975,450

(22) Filed: Oct. 29, 2004

(30) Foreign Application Priority Data
Oct. 31, 2003 (JP) 2003-371496

(51) Int. Cl. G01N 21/88

(52) U.S. Cl. 356/237.2

(57) ABSTRACT

The present invention provides an apparatus capable of, and a method for, inspecting at high speed and with high accuracy the super minute foreign particles and pattern defects occurring during device-manufacturing processes in which circuit patterns are to be formed on a sample such as a substrate of semiconductor devices and other elements: in the invention, the sample is illuminated in a dark field from multiple directions each of a different incident angle, the light scattered from the sample during the dark-field illumination is detected in each of the multiple directions, and the signals obtained by detecting the scattered light in each direction; thus, defects present on the surface of an optically transparent film of the sample, and defects present in or under the transparent film are discriminated from each other and both types of defects are discriminatively reviewed using a scanning electron microscope.

### BACKGROUND OF THE INVENTION

The present invention relates to a method and apparatus for inspecting the defects occurring in semiconductor-manufacturing processes, and more particularly, to a method and apparatus suitable for closely reviewing defects using a scanning electron microscope.

In semiconductor-manufacturing processes, the presence of foreign particle on semiconductor substrate (wafer) causes insulation defect and short circuit defect of wiring. In addition, as semiconductor elements are followed on being formed super minute pattern, superfine foreign particles also cause insulation defects in capacitors and the destruction of gate oxide films or the like. These foreign particles enter in the semiconductor wafer in various states by various reasons (various causes) such as origination from the movable section of a transfer apparatus, origination from the human body, production by reaction inside a processing apparatus due to process gas usage, or entrainment in chemicals or materials. As the various states, scratches on semiconductor wafers, residues of a material and particles etc. can be mentioned, for example. On the result, these entered foreign particles A foreign substance will affect manufacturing throughput of the semiconductor elements.

It is therefore necessary to detect the defects that have occurred on semiconductor substrates in manufacturing processes, classify detected defects, immediately locate the sources of the defects, and prevent the occurrence of defects in great quantities.

The conventional methods of seeking for the causes of defects in this way comprises a step of identifying position of defects on the surface of the substrate by using an optical type of foreign particle inspection apparatus or an optical-type visual inspection apparatus and a step of presuming the cause of generating of the defect by using a review apparatus such as a scanning electron microscope (SEM). In the optical type of foreign particle inspection apparatus, the positions of defects on a semiconductor substrate are identified by illuminating dark-field illumination to the surface of the substrate and then detecting light scattered from foreign particles present on the substrate. In the optical-type visual inspection apparatus, the positions of defects on a semiconductor substrate are identified by detecting a bright-field optical image being generated from the substrate and then comparing this image with a reference image. Then, in the review apparatus, the step of presuming the cause of generating of the defect includes the steps of classifying the defects identified the position by reviewing in close the defect by the SEM and comparing this classified defect with the database.

These review methods are disclosed in Japanese Patent Laid-Open Nos. 2001-133417, 2003-7243, Hei 05-41194, and others.

During the detection of foreign particles on the surface of a semiconductor substrate using an optical type of foreign particle inspection apparatus, the surface of the semiconductor substrate is scanned and illuminated by increasing the spot size of the laser beam for illuminating the substrate surface in a dark field in order to increase inspection throughput. For this reason, large-error components are contained in the accuracy of the position coordinates calculated from the position of the laser beam spot scanning the surface of the semiconductor substrate.

If closely reviews based on the defect position information containing these large-error components are to be conducted using an SEM, the defect to be observed may not be covered in the image captured by the SEM used for reviewing at magnifications much higher than those of the optical-type foreign particle inspection apparatus. In such a case, although the intended defect is to be searched for by moving the visual field of the SEM in order for the defect to come into this field, the search requires a long time, resulting in SEM review throughput decreasing.

Also, in the method that uses an optical-type visual inspection apparatus, the semiconductor substrate to be inspected is illuminated in a bright field and then the image obtained by imaging is compared with a reference image to detect defects. However, if the surface of the semiconductor substrate is covered with an optically transparent film, the defects detected will be defects present in or under the optically transparent film, as well as those present on the film.

If it is going to review (observe) the defects in close by SEM based on position information of the defects detected by using the optical-type visual inspection apparatus, in SEM, since only the information on the surface of the sample is generally acquired, the defect that exists in or under the film detected with the optical-type visual inspection apparatus is undetectable. In such a case, there has been the problem that the SEM-aided review apparatus recognizes that the optical-type visual inspection apparatus has made errors in detection.

### SUMMARY OF THE INVENTION

The present invention is a method and apparatus for conducting SEM-aided close reviews on the defects detected by using an optical type of foreign particle inspection apparatus or an optical-type visual inspection apparatus so that the detected defects can be reliably placed within the reviewing field of view of the SEM.

More specifically, an object of the present invention is to provide a defect-reviewing apparatus including: a detection optical system which detects a second position information of defects on a surface of a sample which a repetition pattern previously is formed and an optically transparent film is covered, on the basis of first position information of the defects on the sample that have been previously detected by using an external inspection apparatus; a position correcting unit which corrects the first position information of the defects on the sample, on the basis of the second position information of the defects detected by the detection optical system; a scanning electron microscope which reviews (observes) the defects on the sample that were detected by using the external inspection apparatus, on the basis of the position information of the defects corrected by the position correcting unit; a table (stage) which moves the sample whose defects are detected by the optical detection means, to the scanning electron microscope; and a vacuum chamber which provides the detection optical system and the scanning electron microscope in addition to the table included in an interior, the interior being exhausted into a vacuum state. In this configuration, the detection optical system includes: a bright-field image acquisition unit which acquires a bright-field image of the sample by conducting bright-field illumination; a dark-field image acquisition unit which acquires dark-field images of the sample by conducting sequential dark-field illuminations from plural directions different from one another in terms of incident angle; and an image-processing unit which detects the defects on the sample by processing the bright-field image acquired in the bright-field image acquisition unit or the dark-field images acquired in the dark-field image acquisition unit; wherein the image-processing unit is configured so that the defects on the sample can be detected, and a defect existing on the optically transparent film and a defect existing in or under the optically transparent film can be discriminated (identified), by processing the dark-field images obtained by the sequential dark-field illuminations to the sample.

Another object of the present invention is to provide a defect-reviewing method including the steps of: detecting by using a detection optical system, defects on a sample which a repetition pattern previously is formed and an optically transparent film is covered, on the basis of first position information of the defects on the sample that have been previously detected by using an external inspection apparatus; correcting the first position information of the defects on the sample, on the basis of the detected position information of the defects; and reviewing (observing) via a scanning electron microscope, the defects on the sample that were detected by using the external inspection apparatus, on the basis of the corrected position information of the defects. In this defect-reviewing method, during the step of detecting the second position information of defects on the basis of the first position information, the sample is illuminated in a dark field from plural directions different from one another in terms of incident angle, then the scattered light generated from the sample by the dark-field illumination of each of the plural directions is detected, and the signals obtained by detecting the scattered light in each of the plural directions are processed in order for the defects so as to discriminate (identify) a defect existing on a surface of the optically transparent film and a defect existing in or under the optically transparent film of the sample. Also, during the step of reviewing the defects via the scanning electron microscope, includes the step of reviewing (observing) the defect discriminated (identified) as the defect existing on the surface of the optically transparent film of the sample.

According to the present invention, when the defects detected with an optical type of extraneous substance inspection apparatus or an optical-type visual inspection apparatus are to be closely reviewed by using an SEM, it is possible to reliably move detected defects into the reviewing field of view of the SEM and thus to improve throughput in SEM-aided close reviewing of the defects.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a front view showing a schematic configuration of an object surface defect inspection apparatus according to the present invention;

FIGS. 2(a) and 2(b) are schematic configuration diagrams explaining a configuration of the optical system for illumination, shown in FIG. 1;

FIG. 3 is a layout diagram explaining the configuration of the optical system for illumination;

FIG. 4 is a schematic configuration diagram explaining a configuration of the optical system for detection, shown in FIG. 1;

FIGS. 5(a) to 5(c) are diagrams explaining the spatial filters of the optical system for detection, shown in FIG. 4;

FIGS. 6(a) and 6(b) are diagrams that explain processing intended to calculate defect coordinates from a detected image;

FIG. 7 is a diagram explaining a sectional profile of the defect image shown in FIGS. 6(a), 6(b);

FIG. 8 is a block diagram explaining the signal-processing block shown in FIG. 1;

FIGS. 9(a) to 9(c) are diagrams showing other embodiments of the optical system for illumination;

FIGS. 10(a) and 10(b) are diagrams that explain methods of illumination for detecting defects on a transparent film;

FIGS. 11(a) and 11(b) are configuration diagrams showing yet other embodiments of the optical system for illumination;

FIGS. 12(a) to 12(c) are configuration diagrams showing other embodiments of the defect detection devices shown in FIG. 1;

FIG. 13 is a flow diagram of SEM reviewing the defects detected by the defect detection device shown in FIG. 1; and

FIGS. 14(a) and 14(b) are block diagrams showing the whole configuration of the present invention.

### DESCRIPTION OF THE PREFERRED EMBODIMENTS

Embodiments of the present invention are described below using the accompanying drawings.

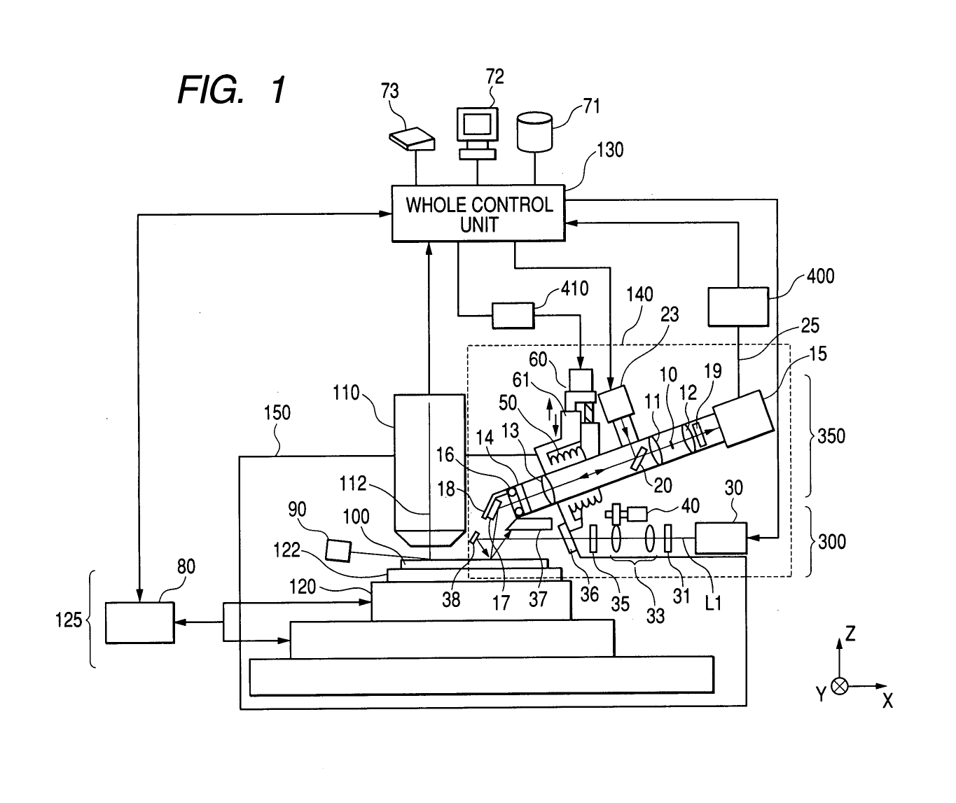

As shown in FIG. 1, the object surface defect inspection apparatus constructed according to the present invention includes: a transfer system 125 equipped with an XY stage 120 for resting and moving a substrate 100 to be inspected (such as any one of the wafers obtained from a variety of product types and manufacturing processes), and with a controller 80, a dark-field illumination system 300 that sets the laser light L1 emitted from a laser light source 30, to a size via a beam diameter-changing element 33 and then provides irradiation from a diagonally upward direction of the substrate 100 via a retardation plate (½ λ plate) (what rotates the polarization direction 90 degrees) 35 and a mirror 38, a defect detection device 140 that has a detection optical system 350 including objective lenses 13, a beam splitter 20, a first lens group 11, a spatial filter 10, a second lens group 12, an optical filter 19, and a light detector 15 such as a charge-coupled device (CCD), these system components being arranged above a table of the XY stage 120 for resting the substrate 100, a signal processor 400 for detecting defects from the image signal that is output from the light detector 15 located inside the detection optical system 350, and a whole control unit (a main control unit) 130 for conducting whole sequence control, the whole control unit 130 having an input/output unit 73 (including a keyboard and a network), a display unit 72, and a storage unit 71.

A scanning electron microscope (SEM) 110 with an electron beam axis 112 is provided at a position coaxial with the defect detection device 140 in a Y-direction thereof, and spaced from the defect detection device 140 by a distance of “d” in an X-direction thereof. The SEM 110 is an apparatus that irradiates an electron beam onto the substrate 100 to scan it and then to review (observe) images at high magnifications by detecting the secondary electron generated from the substrate. After another inspection apparatus has detected any defects on the substrate 100 and output defect map data to the SEM 110, the SEM receives the defect map data as position information on the detected defects, via the input/output unit 73 (keyboard and network included). On the basis of the defect map data, the SEM 110 moves the XY stage 120 to a position almost matching the electron beam axis 112 of the SEM 110 in XY directions thereof. After this, a focus detection system 90 (in FIG. 1, only the light-projecting side is shown and the light-receiving side is omitted) detects a position on the substrate 100 in a Z-direction thereof, and the SEM 110 reviews (observes) each defect on the substrate 100 while the whole control unit 130 is controlling a focus of the electron beam in order to obtain a clear SEM image. A secondary-electron detector (not shown) includes, for example, an electron dispersive X-ray (EDX) analyzer, and a photo-electric converter provided so as to face a crossing point of the electron beam axis 112 and the substrate 100.

Next, the dark-field illumination system 300 is described below using FIGS. 1 to 3. The laser light L1, after being emitted from the laser light source 30, passes through a shutter 31 opened or closed by the appropriate driving signal sent from the whole control unit 130. Next, the laser light L1 enters the inside of a vacuum chamber 150 through the beam diameter-changing element 33, the retardation plate 35, and a window 36, and reflects at the mirror 38 or a mirror 39 (the two mirrors differ from each other in reflection angle), and is irradiated onto the surface of the substrate 100. At this time, the light scattered from the defects on the surface of the substrate 100 reaches the detection optical system 350 having an optical axis 312, and regularly reflected light reaches a light attenuator 37. The light attenuator 37 is an optical element acting to cancel incident light by means of absorption, interference, and/or the like, and has a needle-like protrusion formed on the surface in order to acquire the incident light.

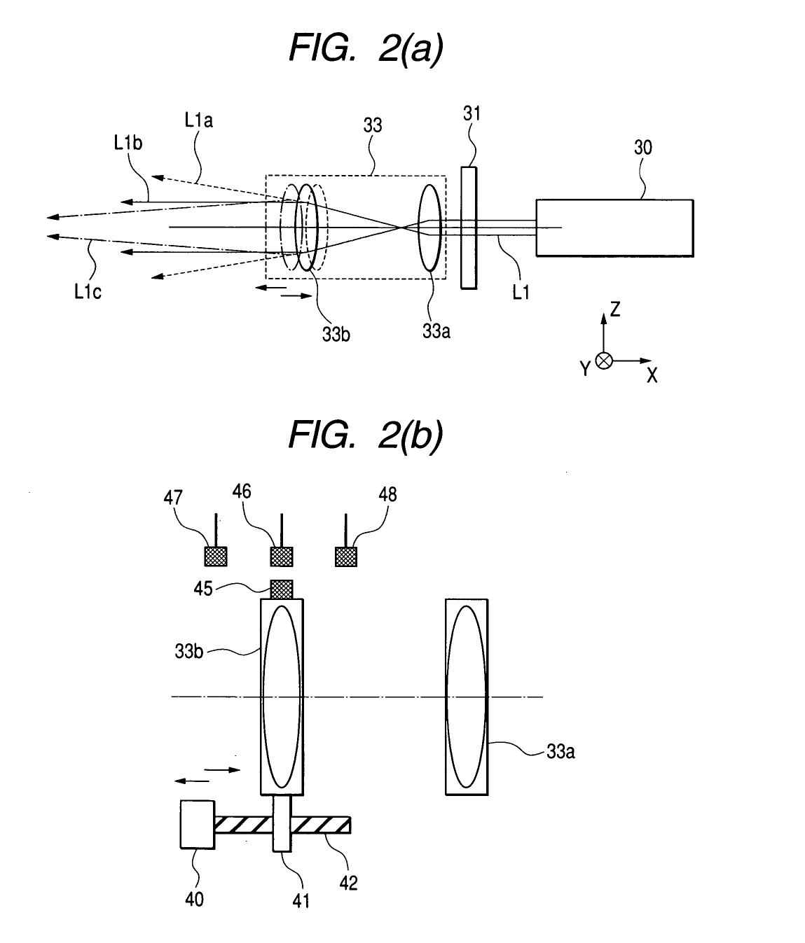

The beam diameter-changing element 33 is, as shown in FIGS. 2(a), 2(b), constituted by, for example, two groups of lenses, 33a and 33b. The lens group 33b is driven in an optical-axis direction (X-direction) via a lens holder 41 by a motor 40 (e.g., a pulse motor) and a ball screw 42. The lens group 33b is adapted to change an irradiation range by converging the pencil of laser light irradiated onto the surface of the substrate 100 to be inspected. That is to say, after a movable portion 45 of a positioning sensor provided at a front end of the lens holder 41 has detected a position of a home position sensor 46, rotation pulses of the motor 40 are controlled via a controller not shown, by use of the driving signal sent from the whole control unit 130.

Sensors 47 and 48 are limit sensors installed across the home position sensor 46. An optical sensor, a magnetic sensor, or the like is usable as the positioning sensor. Successive operation of these sensors is controlled in accordance with a command from the whole control unit 130. The illumination range is set synchronously with detection magnification selection of the detection optical system 350. The illumination range is determined by beam diameter and the relationship in position of the lens group 33b. Illumination range data is prestored within the whole control unit 130, and can also be measured by providing a calibration plate (not shown) or the like on part of a resting table 122.

The detection optical system 350 has an optical axis at a position spaced from the electron beam axis 112 of the SEM 110 by a distance of “d”, and the entire optical system is movable in a Z-direction by a Z-stage 61. The Z-stage 61 moves in a Z-direction by rotation control of a motor 60 controlled by a control driving circuit 410. The motor 60 is controlled via the control driving circuit 410 by the appropriate control signal sent from the whole control unit 130. The detection optical system 350 and the vacuum chamber 150 are connected by a deformable coupling 50 and constructed so that even while the Z-stage is moving, the degree of vacuum inside the vacuum chamber is maintained.

That is, the detection optical system 350 includes, as shown in FIG. 4, a mirror 17, objective lenses 13, a beam splitter 20, a first lens group 11, a spatial filter 10, a second lens group 12, an optical filter 19, and a light detector 15. The detection optical system 350 detects the light L3 scattered from a defect 55 present on the surface of the substrate 100 to be inspected. It is possible to use, as the laser light source 30, a laser (or the like) that emits light of a single or white color falling within a visible or ultraviolet light region. The light detector 15 uses light-receiving elements having light-receiving sensitivity with respect to a wavelength of the light emitted from the laser light source 30.

An exit window 14 is a transparent window provided between the objective lenses 13 and the mirror 17, and the degree of vacuum inside the vacuum chamber 150 is maintained by a vacuum sealing material 16. The defect-scattered light L3, after passing through the objective lenses 13, passes through the beam splitter 20 and then reaches the light detector 15 via the first lens group 11, the spatial filter 10, and the second lens group 12. The light detector 15 is, for example, a TDI sensor or CCD that has a one-dimensional or two-dimensional array of light-receiving elements (pixels), and has a function that changes a received-light accumulation time. The signal processor 400 then processes the electrical signal output from the light detector 15, and processing results are sent to the whole control unit 130.

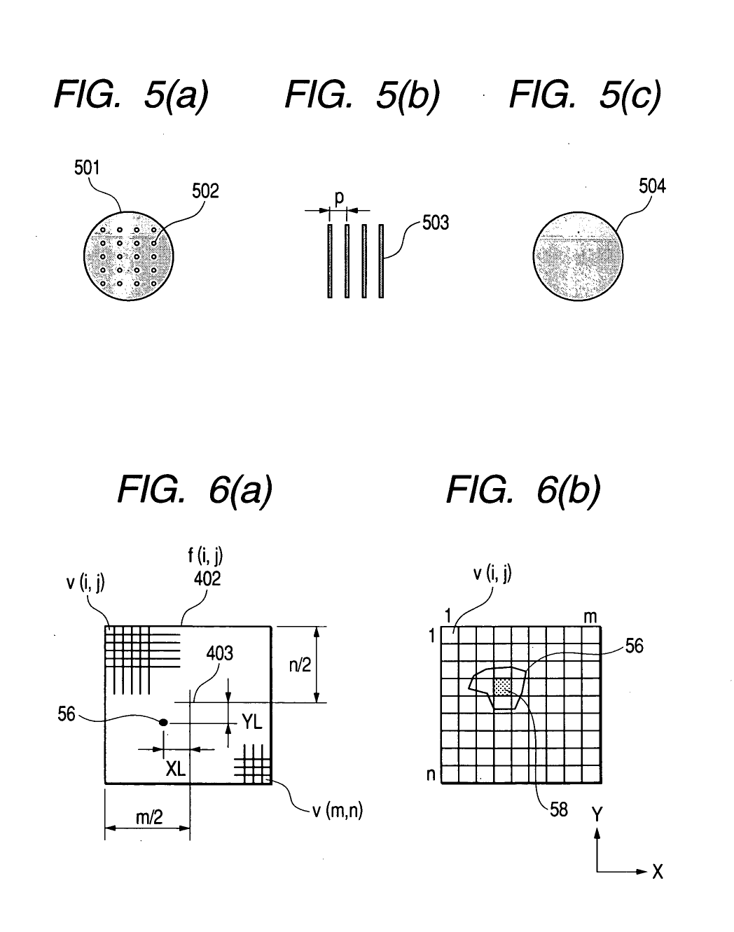

The spatial filter 10 is disposed at a Fourier transformation position (equivalent to an exit pupil) of the objective lenses 13, and shields the light reflected from the substrate 100 (e.g., a Fourier image due to reflected/diffracted light from a regular repetition pattern or the like). Such light becomes noise when defects or foreign particles are detected. For example, when a pupil-reviewing optical system 200 formed up of a mirror 201 retractable in a Y-direction during inspection, a projection lens 202, and a TV camera 203, is provided in an optical path of the detection optical system 350 and then a reflected/diffracted light image 501 (shown in FIG. 5(a)) from a repetition pattern at the Fourier transformation position is acquired using the TV camera 203, the spatial filter 10 shields luminescent spots 502 of the diffracted image by means of a light-shielding plate 510 having a rectangular light-shielding pattern 503.

The light-shielding pattern 503 can have its pitch “p” variable via a mechanism not shown, and is adjusted so that the image acquired by the TV camera 203 will be an image 504 free of a luminescent spot. The signal processor 400 processes the appropriate signals sent from the TV camera 203 and conducts adjustments based on commands from the whole control unit 130. The spatial filter 10 can be installed in and retracted from an optical path via a movement element 21.

When defects present on the substrate 100 to be inspected are reviewed with the SEM, the substrate 100 is unloaded from a substrate cassette (not shown) by a robot arm, transferred onto the resting table 122 of the XY stage 120 by the transfer system 125, and fixed in place.

Next, the defects to be reviewed are positioned on the optical axis of the detection optical system 350 in accordance with the defect map data outputted from the external inspection apparatus after being previously input from the input/output unit 73 to the whole control unit 130. Images of the defects are then acquired by the light detector 15 and input to the signal processor 400. The signal processor 400 detects the defects from the input images and outputs detection results to the whole control unit 130.

The whole control unit 130 issues a driving signal to the XY stage 120 via the driving circuit, and the XY stage 120 moves in the X-direction through the spacing distance “d” between the electron beam axis 112 of the SEM and the optical axis 312 of the detection optical system 350. The defects that were detected by the defect detection device 140 are then moved onto the electron beam axis 112 of the SEM, and the defects are confirmed and analyzed. On the display unit 72, an image to be reviewed through the SEM and the image that was acquired by the light detector 15 can be displayed for reviewing, by selecting either image or by arranging both images on one screen. If no defects are detected in the signal processor 400, the detection optical system is to have its detection field on the substrate 100 enlarged or reduced to search for defects. At this time, the illumination range of the laser light L1 is also to be varied by moving the lens group 33b.

Next, detection of defects from the image that was acquired by the light detector 15 is described below. FIGS. 6(a), 6(b) are schematic diagrams showing a light-receiving surface of the light detector 15, and these diagrams apply to an arrangement of “m×n” pixels.

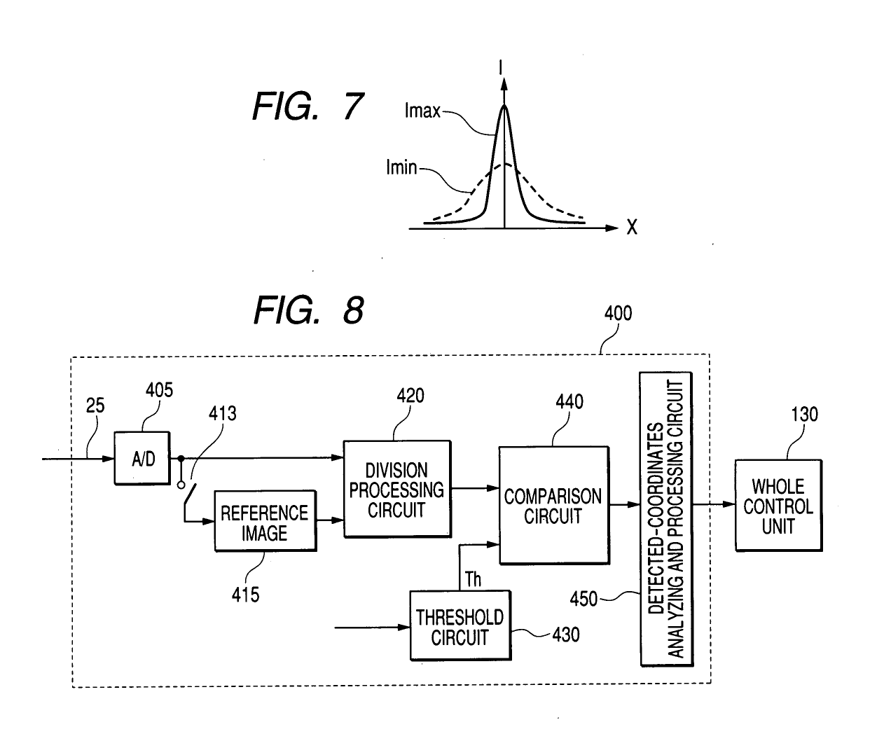

Surface defects of the substrate 100 generate scattered light when illuminated with the laser light L1 from the laser light source 30 or illuminated from a bright-field illumination light source 23. As a result, defect images 56 are formed on light-receiving surface 402 of the light detector 15 and acquired therefrom into the signal processor 400. During the acquisition of these images, focus is changed by moving the Z-stage 61 step-by-step in predetermined increments in the Z-direction. A position in the Z-direction where luminance I in an X(Y) direction of one defect image 56 takes a maximum value of Imax in FIG. 7 is taken as a just-in-focus position. Differences XL, YL between a central position 403 of the light-receiving surface 402 and a position of the defect image 56 thereon, with respect to the image obtained at the above position in the Z-direction, are calculated and these values are used as offset values when the defect is moved to a position on the electron beam axis of the SEM optical system. For example, if the defect image 56 spans over multiple pixels as shown in FIG. 6(b), center-of-gravity pixels 58 are stored as typical coordinates of the defect.

FIG. 8 shows a configuration of the signal processor 400. An image signal 25 that has been output from the light detector 15 is converted from analog form into digital form by an A/D converter 405 and then input to a division processing circuit 420. The division processing circuit 420 matches a position of a reference image 415 free from defect information, and a position of the image output from the light detector 15, and then after performing divisions for each pixel, outputs division results to a comparison circuit 440.

The comparison circuit 440 conducts pixel-by-pixel comparisons between a threshold “Th” that has been output from a thresholding circuit 430, and the output of the division processing circuit 420. This means that the comparison circuit 440 sets the threshold “Th” with respect to a brightness signal of each pixel of a two-dimensional image “f(i, j)” and judges whether the pixel is in excess of the threshold. The comparison circuit 440 assigns “1” to each pixel exceeding the threshold, and “0” to all other pixels, and outputs judgment results to a detected-coordinates analyzing and processing circuit 450.

The detected-coordinates analyzing and processing circuit 450 takes only “1” pixels of all input image signals, as defect candidates, stores coordinates of a pixel of a center of gravity as coordinates of a defect into the whole control unit 130, and compares the coordinates of the defect with the defect map coordinates being previously inputted from the external inspection apparatus. If both sets of coordinates are outside the field of the detection optical system 350 on the wafer 100 of the light detector 15, the coordinate positions are updated. In all other cases, reference is made to the defect map coordinates.

Either the shading image of illumination light that was acquired prior to the inspection, or image data that was obtained by imaging the chips or memory cells repeatedly formed on the substrate 100 is used as the reference image 415. In this configuration, the reference pattern image that originally is to take the same shape as that of the to-be-inspected pattern existing at the chips or memory cells arranged adjacently to or in the neighborhood of the defect coordinates can be selected by opening/closing a switch provided in related circuits when the XY stage 120 is moving with the spatial filter 10 remaining disposed in the optical path of the detection optical system 350.

Higher-density integration of semiconductors is bringing about a tendency towards further super minute reduction in the line widths of the patterns formed on the substrates 100 to be inspected. Since pattern edges each have a shape with super minute depressions and protrusions, laser light irradiation results in speckle noise arising from the edges. The speckle noise changes a scattering state of light at the edges according to particular laser light irradiation conditions. Accordingly, even for patterns of the same shape, the pattern images detected by the light detector 15 differ from one another in terms of shape, and during chip comparison, the corresponding portions are judged to be mismatching and normal portions are recognized as defects. For these reasons, the need has arisen to ensure stable detection of patterns by reducing the speckle noise at the pattern edges.

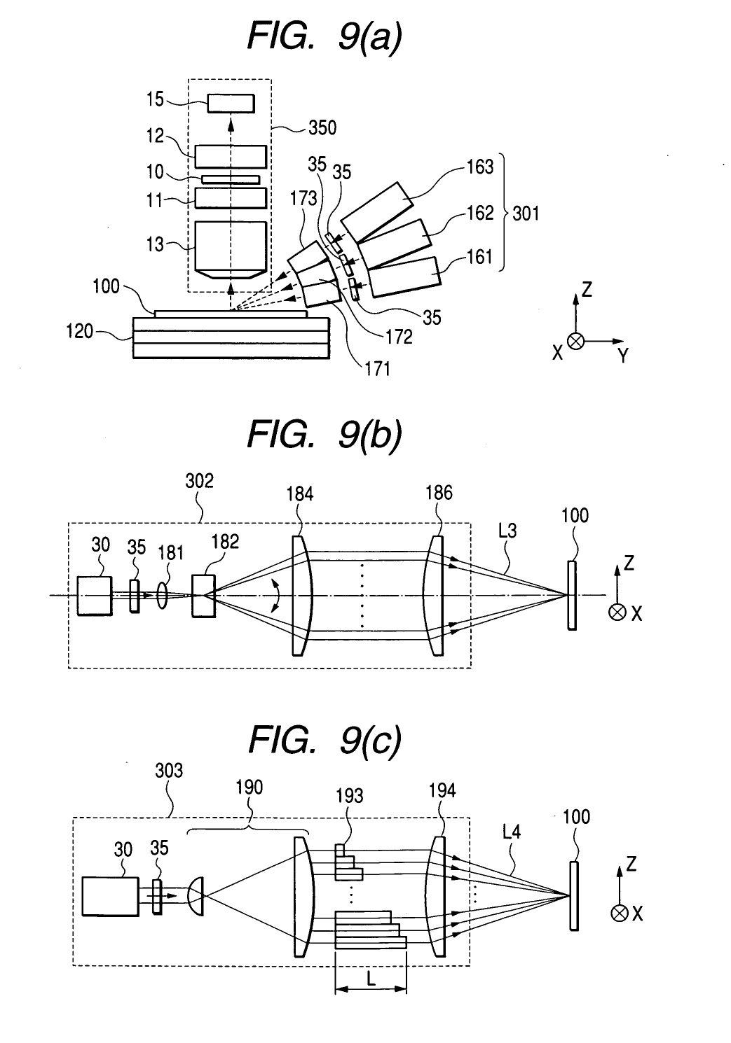

Therefore, a configuration in which directivity of the speckle noise at pattern edges can be suppressed by, as shown in FIGS. 9(a) to 9(c), irradiating light from plural different directions with respect to the surface of the substrate 100 to be inspected has been adopted for the dark-field illumination system. This configuration has made it possible to reduce the speckle noise at pattern edges within a detection field of the light detector 15 and hence to stably detect patterns.

FIG. 9(a) shows an example of a dark-field illumination system 301 in which the surface of a substrate 100 to be inspected is illuminated so as to reduce the speckle noise by combining light sources 161 to 163 of the same wavelength or of different wavelengths and condensing lenses 171 to 173. The light sources 161 to 163 illuminate the surface of the substrate 100 continuously or discontinuously by means of switch elements (not shown) arranged inside the light sources themselves or in optical paths thereof. An exposure time synchronous with surface illumination of the substrate 100 by the light sources 161 to 163 is set for a light detector 15.

FIGS. 9(b) and 9(c) show embodiments of illuminating the substrate 100 so as to reduce the speckle noise from plural directions using a single light source.

The dark-field illumination system 302 shown in FIG. 9(b) irradiates lights (the S polarization laser light L(S) and the P polarization laser light L(P)) from a laser light source 30 onto the surface of a substrate 100 via a condensing lens 181, a scanning element 182, a collimator lens 184, a condensing lens 186, and the each of mirrors 38 and 39 (not shown). More specifically, laser light that has been condensed within the scanning element 182 by the condensing lens 181 is irradiated for scanning in, for example, the Z-direction by use of an acousto-optic (AO) deflector, a microdevice mirror, a galvanomirror, and/or the like, under the state where one scan cycle of time of the laser light and an exposure time of light detector 15 are synchronized. Thus, the surface of the substrate 100 is illuminated with laser light L3 so as to reduce the speckle noise from a direction different in terms of time.

The dark-field illumination system 303 shown in FIG. 9(c) is an example not requiring the above-mentioned scanning element 182. In this example, after laser light has been spread in any direction by a beam expander 190, transparent rods 193 different from one another in terms of length L are arranged on an optical path and laser light L4 is irradiated from a different direction onto one section (a same portion) of the surface of a substrate 100 via a condensing lens 194 provided facing an exit end of each transparent rod 193 and the each of mirrors 38 and 39. An incident plane of each transparent rod 193 is set to fit a particular illumination region of the substrate 100, and length L of each transparent rod 193 is set so that the difference in length L between any two rods matches an optical path length difference equal to or greater than a coherence length of a light source 30 so as to reduce the speckle noise. In addition, each of the dark-field illumination system 301-303 is provided the retardation plate 35 which converts to each of S polarization laser light L(S) and the P polarization laser light L(P).

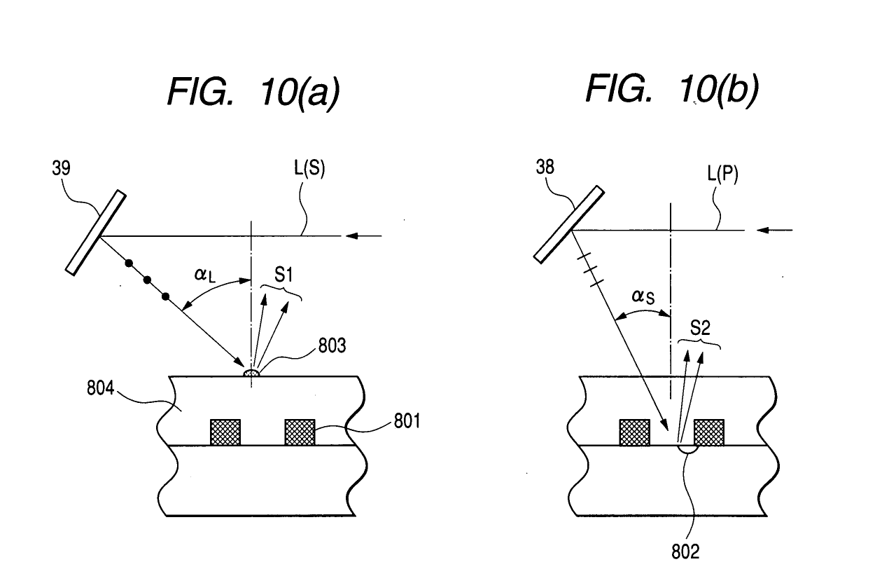

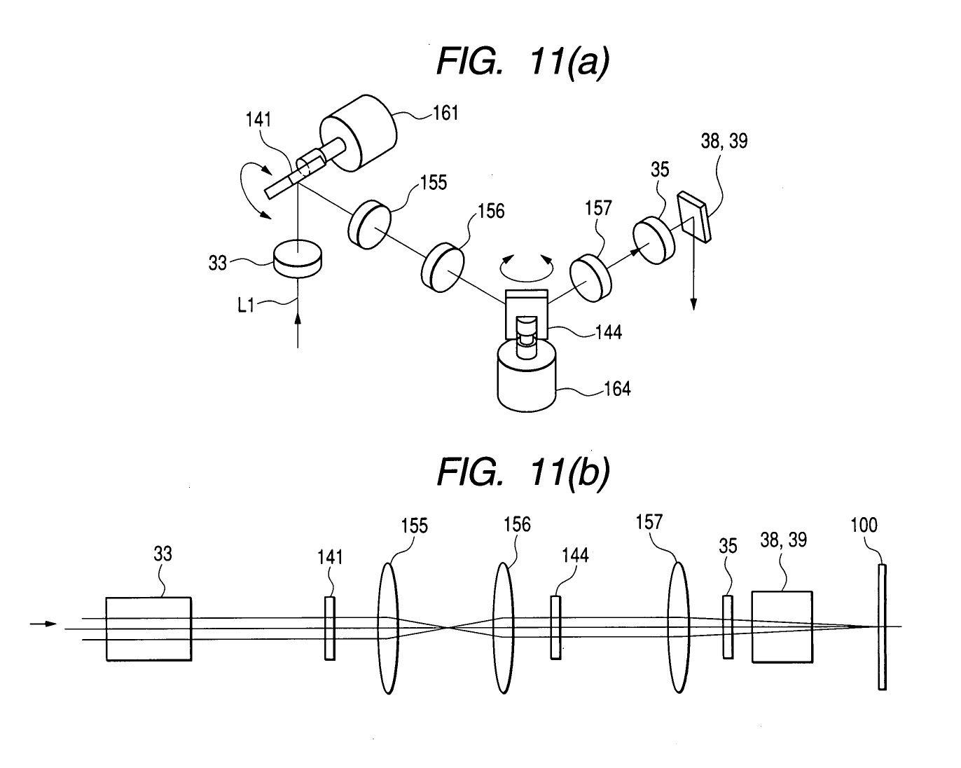

As shown in FIGS. 10(a), 10(b), the surface of the substrate 100 to be inspected has a transparent film (e.g., oxide film) 804 formed during a multilayering process, and a process of forming patterns on that film is repeated to form a multilayer wafer. The need for detecting only the foreign particle 803 and pattern defect existing on the surface of the oxide film of the wafer is increasing. During the use of a pattern/foreign particle inspection apparatus, however, illumination light also reaches the inside of the transparent film and is irradiated to any defects existing therein. Therefore, not only the defect and the foreign particle 803 on the transparent film surface, but also the defect and foreign particle 802 inside the transparent film are detected, so both the surface defect/foreign particle and the in-film defect/foreign particle are considered to be mixedly present in an inspection map of the pattern inspection apparatus.

It is understood, however, that the defect 802 inside the transparent film is difficult to review using the SEM. For this reason, even if the defect coordinates are positioned directly under the electron beam axis 112 of the SEM, the defect cannot be confirmed and thus the pattern inspection apparatus may be recognized as having made a mistake in detection. In the present invention, therefore, when light is illuminated, an angle of the illumination is changed according to particular angles of the mirrors 38, 39 arranged in the dark-field illumination system 300. Thus, transmission of the illumination light through the transparent film and reflection of the illumination light are adjusted for greater quantities of light illuminated to either the surface defects or the in-film defects. This allows the detection optical system 350 to determine whether the defects that have been detected by the optical-type visual inspection apparatus are defects present on the film or inside the film, and hence allows feedback to the SEM. The mirror 38 is constructed so that illumination light of a small incident angle (close to a vertical angle) illuminates any defects present inside the transparent film, and the mirror 39 is constructed so that illumination light of a large incident angle (close to a horizontal angle) illuminates the surface of the transparent film in great quantities.

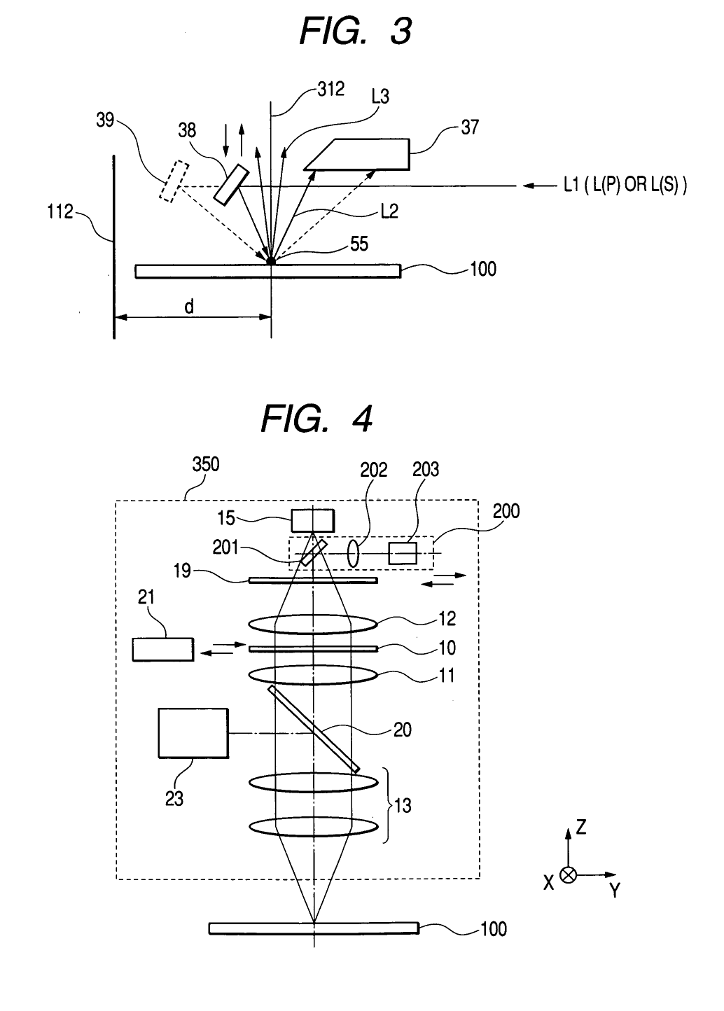

That is to say, by rotating a retardation plate 35 disposed on an optical path around its optical axis by using a rotating drive means (not shown), there are a case of S polarization which makes direction of linear polarization of laser light vertical to the paper surface of FIG. 3, and a case of P polarization which makes it parallel to the paper surface. A reflection film having such characteristics that the S polarization laser light L(S) is all reflected by the mirror 39 and the P polarization laser light L(P) is all reflected by the mirror 38, is formed on the each surface of mirrors 38 and 39. The optimum illumination angle value of each mirror is set from the results obtained from both.

In the construction as described above, in the case of S polarization which makes direction of linear polarization of laser light vertical to the paper surface of FIG. 3 by adjusting a rotation angle of the retardation plate 35, the S polarization laser light L(S) enters to the mirror 39 by evacuating the mirror 38 to a position outside the optical path of the S polarization light L(S) by a driving means (not shown), all are reflected by the mirror 39, and as shown in FIG. 10(a), reaches the surface of the sample (substrate) at an incident angle of “αL”. Most of the S polarization laser light L(S) that has entered the transparent film 804 at the incident angle of “αL” is reflected on the surface of the transparent film 804, and scattered light S1 generates from the defect 803 on the surface. The scattered light S1 passes through the detection optical system 350 shown in FIG. 1, and reaches the light detector 15, by which S1 is then detected.

Conversely, a case of P polarization which makes direction of linear polarization of laser light vertical parallel to the paper surface by adjusting the rotation angle of the retardation plate 35, the P polarization laser light L(P) enters to the mirror 38 by driving and inserting the mirror 38 into the optical path of the P polarization laser light L(P) by the driving means (not shown), all are reflected by the mirror 38, and as shown in FIG. 10(b), reaches the surface of the sample at an incident angle of “αs”. The P polarization laser light L(P), after entering the transparent film 804 at the incident angle of “αs”, is irradiated to the defect 802 in or under the film, and scattered light generates from the defect 802. Scattered light S2 also generated from the defect 802 in or under the film passes through the detection optical system 350 shown in FIG. 1, and reaches the light detector 15, by which S2 is then detected.

During illumination with the light reflected by the mirror 38, scattered light is generated from the defect 803 on the surface of the transparent film 804 and from the defect 802 within the film. But, during illumination with the light reflected by the mirror 39, scattered light is not generated from the defect 802 within the transparent film 804. Therefore, depending on the presence/absence of the defect signal detected by the light detector 15 and selection of the reflection mirror 38 or 39, it is possible to identify (discriminate) whether the defect is the defect 803 present on the surface of the transparent film 804 or the defect 802 present in or under the film. In other words, information on the light scattered from the defect 803 on the surface of the transparent film 804 can be discriminated from information on the light scattered from the defect 802 in or under the film.

If no defects have been detected in the signal processor 40, although the detection field of the detection optical system on the substrate 100 is to be enlarged for defect searching, illuminance per unit area decreases since the illumination range of the laser light L1 is also enlarged. As shown in FIGS. 11(a), 11(b), therefore, the surface of the substrate 100 is scanned with the laser light L1 in XY directions to minimize decreases in the illuminance of the illumination light.

More specifically, the laser light L1 that has passed through a beam diameter-changing element 33 is reflected as a parallel pencil of rays by a mirror 141, and after being condensed by a lens 155, becomes a parallel pencil of rays once again before reaching a lens 156. After that, L1 is reflected by a mirror 38 or 39 via a lens 157 and then condensed in spot form onto the surface of the substrate 100. The mirror 141 and a mirror 144 are installed on the motors 161 and 164, respectively, that rotate or oscillate by means of electrical signals, and thus the surface of the substrate 100 can be two-dimensionally scanned with the laser light L1 (L(S) or L(P)). Conducting two-dimensional scans with the laser light L1 (L(S) or L(P)) in this manner makes part of the light scattered from the substrate 100 enter the detection optical system 350, in which the L1 light is detected by the light detector 15.

The electrical signals input to the motors 161, 164 are, for example, triangular wave or saw-tooth signals, and these electrical signals input have their frequency and amplitude determined appropriately according to particular spot size and illumination width of the laser light irradiated, and a light accumulation time of the light detector 15. Also, a two-dimensional vibration mirror formed using semiconductor technology, or a polygonal mirror is usable as a spot-scanning element. Although the mirrors vibrated by motors are shown as an example in the present invention, since the SEM is an apparatus very susceptible to vibration, the SEM needs to be mounted in combination with a vibration-insulating device not shown. A similar effect can also be obtained by using an optical oscillator such as an acousto-optic deflector (AOD).

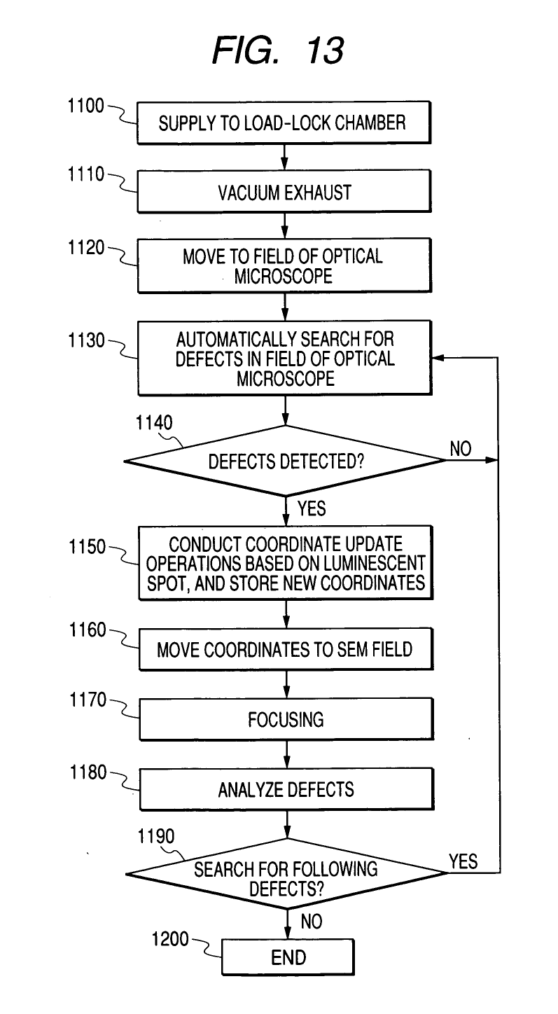

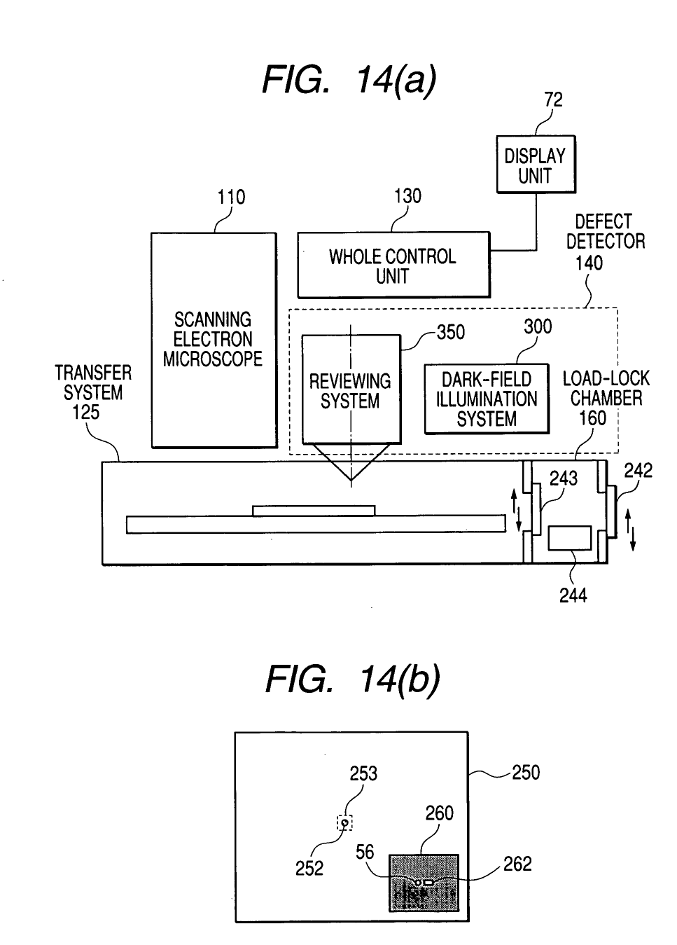

Next, a sequence for inspecting defects using the defect inspection apparatus of the present invention that has the above configuration is described below using FIGS. 13 and 14(a), 14(b).

First, the substrate 100 that has undergone a required processing process in device-manufacturing equipment is inspected using an inspection apparatus not shown (i.e., an optical-type visual inspection apparatus for detecting pattern defects or an extraneous substance inspection apparatus), and defects present on the substrate 100 are detected. Position coordinate information on the detected defects is transferred to the whole control unit 130 via a communications element not shown, and stored into the whole control unit.

Next, the substrate 100 that has been subjected to the defect inspection is stored into a cassette not shown, then carried to a gate valve 242, and in step S110, supplied to a load-lock chamber 160 by opening/closing of the gate valve 242. After this, the load-lock chamber 160 is vacuum-exhausted in step S1110, and after this, a gate valve 243 is opened/closed, whereby a transfer robot 244 positions the substrate 100 onto the XY stage 120 of the vacuum chamber within the SEM and rests the substrate on the XY stage.

In step S1120, in accordance with the position coordinate information that was stored into the whole control unit 130 after the defect detection by the above inspection apparatus not shown, the XY stage 120 is driven to move the coordinate positions of the defects on the substrate 100 to the field of the defect detection device 140. In step S1130, the surface of the substrate 100 is illuminated with laser light from the laser light source 30 for dark-field illumination, and any luminescent spots that indicate defects are automatically searched for within the field of the defect detection device 140. Thus, a defect 803 present on the surface of a transparent film 804 is detected in step S1140. After the movement of the defect coordinate positions, if a desired defect cannot be detected within the field of the defect detection device 140, the XY stage is driven to spread the searching region with the defect coordinates as its reference to conduct searching operations once again.

When the defect 803 on the surface of the transparent film 804 is detected, coordinates of the defect on the substrate 100 remaining rested on the XY stage 120 are derived in accordance with the luminescent spots of a defect detection image within the light detector 15. If the thus-derived coordinate information differs from the defect coordinate data that the inspection apparatus not shown has calculated from the previously detected defects and the difference is in excess of a certain level, the particular defect coordinate data is updated and then stored in step S1150. In this step, the difference exceeding a certain level, for example, an error whose magnitude is such that the image oversteps the detection field of the defect detection device 140, may be usable as a reference value. Alternatively, a definition may be conductible using the amount of pixel shift within the detection field of the defect detected by the defect detection device 140 during position matching based on the defect coordinate data that the inspection apparatus not shown has calculated from the previously detected defects.

If the difference between the above defect coordinate information and defect coordinate data is in excess of a certain level, the coordinate data is modified first, then the substrate 100 is moved by the XY stage 120, and the defect detected by the defect detection device 140 is positioned within a reviewing field of the SEM. Next, after focusing by electron beam adjustment of the SEM, detailed images of the defects are acquired by defect imaging with the SEM, and then reviewed. Use of ADC (Automatic Defect Classification) technology further makes it possible to analyze the SEM-acquired detailed defect images in step S1180 and thus to classify the defects from particular characteristics of the defect images and identify the kinds of defects.

Basically, defect searching uses dark-field illumination with laser light. However, defects can also be detected according to the detection scheme adopted for the above inspection apparatus not shown. For example, if the defect position coordinate information previously stored into the whole control unit 130 following completion of inspection is information that was detected by a bright-field illumination type of defect inspection apparatus not shown, the substrate 100 is illuminated with a bright-field illumination light source 23, then the surface of the substrate 100 is imaged using the detection optical system 350, and defects are detected using the foregoing search method. The XY stage is finely adjusted so that the thus-detected defects are positioned in the center of the field and the defect position information prestored within the whole control unit 130 is modified in accordance with position information on the finely adjusted XY stage.

Alternatively, if the defect position coordinate information previously stored into the whole control unit 130 following completion of inspection is information that was detected by a dark-field illumination type of defect inspection apparatus not shown, a rotation angle of the retardation plate 35 is adjusted using the dark-field illumination system 300, then the laser light emitted from the laser light source 30 is reflected by the mirror 38 or 39, and thus the substrate 100 is illuminated to detect any defects thereof. At this time, scattered dark-field illumination light from the pattern formed on the substrate 100 is shielded by the spatial filter 10 of the detection optical system 350 and only scattered light from detected defects reaches the light detector 15.

As described above, the SEM is basically unable to review accurately the defects existing in the transparent film of the substrate 100. For this reason, signals of scattered light by the defects that were detected using the dark-field illumination system 300 are processed by the signal processor 400, and each defect is identified (discriminated) whether it is the defect 803 existing on the surface of the transparent film 804 or the defect 802 existing in or under the film. Identification results are stored together with position information of the defect into the whole control unit 130, and during SEM reviewing, the results and the defect position information are fed back. The detection can thus be prevented from being determined to be a detection error in the inspection apparatus for detecting defects beforehand (this inspection apparatus is not shown).

In addition, as shown in FIG. 14(b), during defect searching, for example, the dark-field image 260 obtained in the defect detection device 140 by imaging a luminescent spot 56 of a defect by use of the light detector 15 is stored into the whole control unit 130, and then during SEM reviewing, the luminescent spot 56 is displayed, together with the dark-field image 260, in a SEM-reviewing screen 250. Furthermore, an index 253 indicating a reviewing position, and an index 262 are displayed in the SEM-reviewing screen 250 and the dark-field image 260, respectively. Thus, matching in characteristics between the dark-field image and the image reviewed through the SEM can be established in real time by moving both indices in synchronization with a movement stroke of the XY stage.

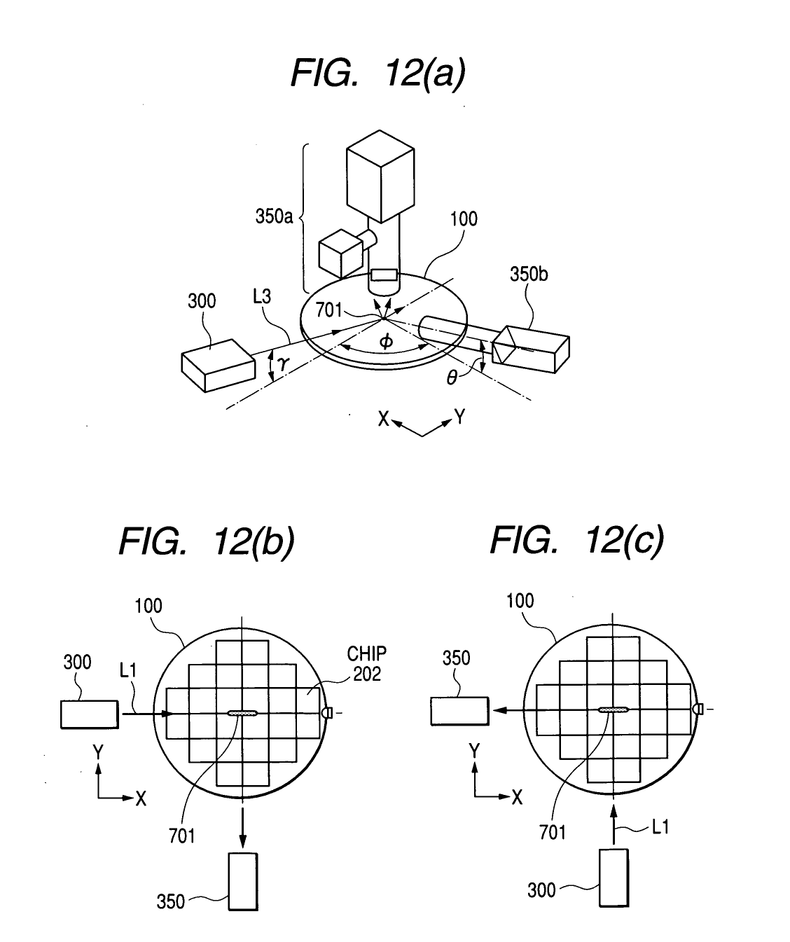

The construction shown in FIG. 12(a) may be adopted for the defect detection device 140 as another embodiment of identifying whether a particular defect is one present on the surface of the transparent film 804 formed on a substrate 100 or one present in the film. More specifically, it is possible to install above the substrate 100 a detection optical system 350a with the same function as that of the foregoing detection optical system 350, and to provide a light source 300 capable of irradiating light from a direction of illumination angle “γ” with respect to the surface of the substrate 100. Furthermore, a detection system 350b can also be provided at a horizontal angle of “φ” in a direction of detection angle “θ”. It is possible, by providing these measures, to suppress the occurrence of stray light from the substrate 100 and detect only very small defects.

As set forth above, according to the present invention, when SEM-aided defect reviewing based on the defect coordinates obtained from inspection with an external inspection apparatus is to be executed, it is possible to discriminatively detect defects present on the surface of the transparent film and defects present in or under the film, and feed back the results during SEM reviewing. It thus becomes unnecessary to conduct an operation in which such defects in or under the transparent film formed on the surface of the substrate under inspection that are difficult to review through the SEM are to be searched for in accordance with the defect coordinates obtained from inspection using an external optical inspection apparatus. Consequently, since the defects on the film surface to be reviewed through the SEM can be reliably and easily moved to stay within the field of the SEM, close reviewing of the defects on the film surface can be conducted easily.

Furthermore, use of the ADC technology allows the kinds of defects to be identified from particular characteristics of SEM-acquired, detailed defect images. Besides, displaying a SEM image and a dark-field image in parallel and adopting index-based navigation yields the effect that the time required for visual defect searching during SEM reviewing can be reduced.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes that come within the meaning and range of equivalency of the claims are therefore intended to be embraced therein.

1. A method for reviewing defects, comprising the steps of:
detecting defect on a sample which a repetition pattern previously is formed and an optically transparent film previously is covered, on the basis of first position information of the defect on the sample that have been previously detected by using an external inspection apparatus;
correcting the first position information of the defects on the sample, on the basis of the detected position information of the defect; and
reviewing via a scanning electron microscope, the defects on the sample that were detected by using the external inspection apparatus, on the basis of the corrected position information of the defect;
wherein the step of detecting the defects includes the steps of illuminating the sample in dark field from plural directions different from one another in terms of incident angle; detecting scattered light generated from the sample by the dark-field illumination in each of the plural directions; and discriminating a defect existing on a surface of the optically transparent film and a defect existing in or under the optically transparent film of the sample by processing image signal detected and obtained in each of the plural directions;
wherein the step of reviewing the defects on the sample includes the step of reviewing the defect discriminated as the defect existing on the surface of the optically transparent film.

2. The method for reviewing defects according to claim 1, wherein the step of correcting the first position information of the defects on the sample includes the step of correcting the first position information of the defects on the sample, on the basis of position information of the defect discriminated as the defect existing on the surface of the optically transparent film.

3. The method for reviewing defects according to claim 1, wherein the step of detecting the defect includes the step of shielding scattered light generated from edges of the pattern previously being formed on the sample among the scattered light generated from the sample by the dark-field illumination in each of the plural directions.

4. A method for reviewing defects, comprising the steps of:
detecting optically defect on a sample which a repetition pattern previously is formed and an optically transparent film previously is covered, on the basis of first position information of the defect on the sample that have been previously detected by using an external inspection apparatus;
correcting the first position information of the defect on the sample, on the basis of the detected position information of the defect; and
reviewing via a scanning electron microscope, the defects on the sample that were detected by using the external inspection apparatus, on the basis of the corrected position information of the defects;
wherein the step of detecting the defects includes the steps of discriminating a defect existing on a surface of the optically transparent film and a defect existing in or under the optically transparent film of the sample about the defect detected optically; and
wherein the step of reviewing the defects on the sample includes the step of reviewing the defect discriminated as the defect existing on the surface of the optically transparent film.

5. The method for reviewing defects according to claim 4, wherein the step of discriminating uses a dark-field image obtained by illuminating the sample from a high-angle direction and a dark-field image obtained by illuminating the sample from a low-angle direction.

6. The method for reviewing defects according to claim 4, wherein the step of detecting the defects includes the step of shielding with a spatial filter scattered light generated from edges of the pattern previously being formed on the sample among the scattered light generated from the sample by each of dark-field illuminations when a dark-field image is obtained by illuminating the sample from a high-angle direction and when a dark-field image is obtained by illuminating the sample from a low-angle direction.

7. An apparatus for reviewing defects, comprising:
a detection optical system which detects optically defect on a sample which a repetition pattern previously is formed and an optically transparent film previously is covered, on the basis of first position information of the defects on the sample that have been previously detected by using an external inspection apparatus;
a defect position information-correcting unit which corrects the first position information of the defect on the sample, on the basis of the position information of the defect detected by the detection optical system;
a scanning electron microscope which reviews the defects on the sample that were detected by using the external inspection apparatus, on the basis of the position information of the defects corrected by the defect position information-correcting unit;
a stage which moves the sample detected by the detection optical system to the scanning electron microscope; and
a vacuum chamber means which provides the detection optical system and the scanning electron microscope in addition to the table included in an interior, the interior being exhausted into a vacuum state.
wherein the detection optical system includes:
a bright-field image acquisition unit which acquires an image of the sample by conducting bright-field illumination;
a dark-field image acquisition unit which acquires another image of the sample by conducting sequential dark-field illumination from a plurality of directions different from one another in terms of incident angle; and
an image processor unit which detects the defects on the sample by processing the image acquired by said bright-field image acquisition unit or the image acquired by said dark-field image acquisition unit: and
wherein said image processor unit detects the defects on the sample and discriminates the defects as a defect existing on the optically transparent film and a defect existing in or under the transparent film by processing the images obtained by the sequential dark-field illuminations of the sample by using said dark-field image acquisition unit.

8. The apparatus for reviewing defects according to claim 7, wherein said defect position information-correcting unit corrects the first position information of the defect on the sample, by using position information of the defect which are detected by said detection optical system and are discriminated as the defect existing on the optically transparent film by the image processor unit.

9. The apparatus for reviewing defects according to claim 7, wherein said detection optical system further includes a spatial filter which shields scattered light generated from edges of the pattern previously being formed on the sample among the scattered light generated from the sample by the dark-field illumination.

10. The apparatus for reviewing defects according to claim 7, wherein said vacuum chamber means further includes a load-lock chamber, and carries the sample from atmosphere through said load-lock chamber into a vacuum chamber.
